(19) United States
(12) Patent Application Publication
(10) Pub. No.: US 2026/0204503 A1
(43) Pub. Date: Jul. 16, 2026

(54) ELECTROMAGNET DEVICE

(71) Applicant: OMRON Corporation, Kyoto-shi, Kyoto (JP)

(72) Inventors: Hiroyuki TANAKA, Kyoto-shi, Kyoto (JP); Kazuya SODA, Kyoto-shi, Kyoto (JP); Takuya KOIZUMI, Kyoto-shi, Kyoto (JP); Sayaka TAJIRI, Kyoto-shi, Kyoto (JP); Masayuki NODA, Kyoto-shi, Kyoto (JP); Masatoshi NISHIDA, Kyoto-shi, Kyoto (JP); Akihiro OSAKO, Kyoto-shi, Kyoto (JP)

(21) Appl. No.: 19/134,218

(22) PCT Filed: Nov. 20, 2023
(86) PCT No.: PCT/JP2023/041586

§ 371 Date: May 30, 2025

(30) Foreign Application Priority Data
Dec. 15, 2022 (JP) 2022-200024

(51) Int. Cl. H01H 50/42; H01H 50/44; H01H 50/64

(52) U.S. Cl. CPC H01H 50/42; H01H 50/44; H01H 50/642; H01H 50/643; H01H 2050/446

(57) ABSTRACT

An electromagnet device includes a coil, a spool, an iron core, a yoke, a movable iron piece, an auxiliary yoke, and a permanent magnet. The coil is wound around the spool. The iron core is disposed inside the spool. The yoke includes a base portion and an extension portion. The base portion extends in a direction intersecting an axial direction of the iron core and is fixed to one end of the iron core. The extension portion is connected to the base portion and is arranged laterally relative to the coil. The movable iron piece is rotatably supported by the extension portion of the yoke. The auxiliary yoke is connected to an exterior of the base portion of the yoke. The permanent magnet is positioned on an extension line of the axis of the iron core and is disposed between the base portion of the yoke and the auxiliary yoke.

### CROSS-REFERENCE TO RELATED APPLICATIONS

This application is the U.S. National Phase of International Application No. PCT/JP2023/041586, filed on Nov. 20, 2023. That application claims priority to Japanese Patent Application No. 2022-200024, filed Dec. 15, 2022. The contents of those two applications are incorporated by reference herein in their entireties.

### FIELD

The claimed invention relates to an electromagnet device.

### BACKGROUND

Conventionally, a latching-type electromagnet device including a permanent magnet has been disclosed (see Japanese Patent Application Publication No. 2014-44838). The permanent magnet is positioned on the extension line of the axis of an iron core and is held between an auxiliary yoke and a yoke. The permanent magnet increases the attractive force of the iron core that acts on the movable iron piece.

In the electromagnet device disclosed in Patent Document 1, an auxiliary yoke is disposed inside the yoke, and the auxiliary yoke is joined to the yoke by laser welding or adhesive with a magnet being sandwiched between the auxiliary yoke and the yoke. Accordingly, assembling the electromagnet device is not easy.

### SUMMARY

An object of the claimed invention is to improve the assemblability of an electromagnet device.

### Solution to Problem

An electromagnet device according to one aspect of the claimed invention includes a coil, a spool, an iron core, a yoke, a movable iron piece, an auxiliary yoke, and a permanent magnet. The coil is wound around the spool. The iron core is disposed inside the spool. The yoke includes a base portion and an extension portion. The base portion extends in a direction intersecting an axial direction of the iron core and is fixed to one end of the iron core. The extension portion is connected to the base portion and is arranged laterally relative to the coil. The movable iron piece is rotatably supported by the extension portion of the yoke. The auxiliary yoke is connected to the base portion of the yoke on an exterior side of the base portion. The permanent magnet is positioned on an extension line of the axis of the iron core and is disposed between the base portion of the yoke and the auxiliary yoke.

In this electromagnet device, the auxiliary yoke is connected to the base portion of the yoke on the exterior side of the base portion, and the permanent magnet is disposed between the base portion of the yoke and the auxiliary yoke. That is, the auxiliary yoke and the permanent magnet are arranged on the exterior of the yoke. With this configuration, the permanent magnet and the auxiliary yoke can be assembled to the exterior of the yoke, thereby improving the assemblability of the electromagnet device. In addition, the electromagnet device according to the claimed invention can be assembled simply, for example, by attaching a permanent magnet and an auxiliary yoke to a conventional hinge-type single-stable electromagnet device from the outside. Furthermore, common components can be used with the conventional hinge-type single-stable electromagnet device except for the permanent magnet and the auxiliary yoke.

The base portion of the yoke may include a first contact portion configured to contact the permanent magnet, a second contact portion configured to contact the auxiliary yoke, and a reduced cross-sectional area portion disposed between the first and second contact portions. The reduced cross-sectional area portion may be spaced apart from the auxiliary yoke in the axial direction and may have a smaller cross-sectional area than a cross-sectional area of the second contact portion. In this case, the magnetic flux of the permanent magnet more easily flows through the magnetic circuit that passes through the movable iron piece, thereby increasing the holding force for retaining the movable iron piece in the operating position.

The reduced cross-sectional area portion may include a through-hole that extends the base portion in the axial direction. In this case as well, the magnetic flux of the permanent magnet more easily flows through the magnetic circuit that passes through the movable iron piece, thereby increasing the holding force for retaining the movable iron piece in the operating position.

The base portion may further include a caulking hole. The through-hole of the reduced cross-sectional area portion may have a width dimension greater than the inner diameter dimension of the caulking hole. In this case as well, the magnetic flux of the permanent magnet more easily flows through the magnetic circuit that passes through the movable iron piece, thereby increasing the holding force for retaining the movable iron piece in the operating position.

The reduced cross-sectional area portion may include a constricted portion. The constricted portion may have a width dimension smaller than the width dimension of the permanent magnet. In this case as well, the magnetic flux of the permanent magnet more easily flows through the magnetic circuit that passes through the movable iron piece, thereby increasing the holding force for retaining the movable iron piece in the operating position.

The reduced cross-sectional area portion may have a thickness smaller than the thickness of the second contact portion. In this case as well, the magnetic flux of the permanent magnet more easily flows through the magnetic circuit that passes through the movable iron piece, thereby increasing the holding force for retaining the movable iron piece in the operating position.

The auxiliary yoke may include a magnet contact portion configured to contact the permanent magnet, a yoke contact portion configured to contact the yoke, an intermediate portion disposed between the magnet contact portion and the yoke contact portion and spaced apart from the yoke in the axial direction, and a first step formed between the intermediate portion and the yoke contact portion. In this case, a magnetic circuit passing through the yoke and the auxiliary yoke can be easily formed.

The auxiliary yoke may further include a second step formed between the magnet contact portion and the intermediate portion. The permanent magnet may contact the second step. In this case, the auxiliary yoke can be positioned by the second step.

The yoke contact portion of the auxiliary yoke may have a bent shape. In this case, the magnetic circuit passing through the yoke and the auxiliary yoke can be formed with a simple structure.

The second contact portion of the base portion of the yoke may have a shape protruding toward the yoke contact portion and may contact the yoke contact portion. In this case, the magnetic circuit passing through the yoke and the auxiliary yoke can also be formed with a simple structure.

The auxiliary yoke may be integral with the yoke. In this case, the number of components can be reduced.

The movable iron piece may include an attracting portion configured to be attracted to the iron core. The attracting portion may include a recess recessed in a direction away from the iron core. In this case, the area of the attracting portion arranged opposite the iron core is reduced, and the magnetic flux flowing from the iron core to the movable iron piece is concentrated, thereby increasing the holding force for retaining the movable iron piece in the operating position.

The attracting portion may further include a first protrusion contactable with the iron core. In this case, the area of the attracting portion arranged opposite the iron core can be reduced, thereby increasing the holding force for retaining the movable iron piece in the operating position.

The movable iron piece may include an attracting portion to be attracted to the iron core. The attracting portion may include a through-hole that penetrates in the axial direction. In this case, the area of the attracting portion that is arranged opposite the iron core is reduced, thereby increasing the holding force for retaining the movable iron piece in the operating position.

The spool may include a positioning portion configured to position the auxiliary yoke. The positioning portion may include a first side wall and a second side wall facing the first side wall. The auxiliary yoke may be held between the first and second side walls. In this case, the auxiliary yoke can be easily positioned.

### BRIEF DESCRIPTION OF THE DRAWINGS

FIG. 1 is a side view of an electromagnetic relay.

FIG. 2 is a partial cross-sectional view of an electromagnet device.

FIG. 3 is a bottom view of a yoke.

FIG. 4 is a diagram illustrating a positioning portion.

FIG. 5 is a diagram illustrating an operating state of the electromagnet device.

FIG. 6 is a diagram illustrating a modification of a reduced cross-sectional area portion.

FIG. 7 is a diagram illustrating a modification of a reduced cross-sectional area portion.

FIG. 8 is a diagram illustrating a modification of a yoke and an auxiliary yoke.

FIG. 9 is a diagram illustrating a modification of a yoke and an auxiliary yoke.

FIG. 10 is a diagram illustrating a modification of an attracting portion of a movable iron piece.

FIG. 11 is a diagram illustrating a modification of an attracting portion of a movable iron piece.

FIG. 12 is a diagram illustrating a modification of an attracting portion of a movable iron piece.

### DETAILED DESCRIPTION

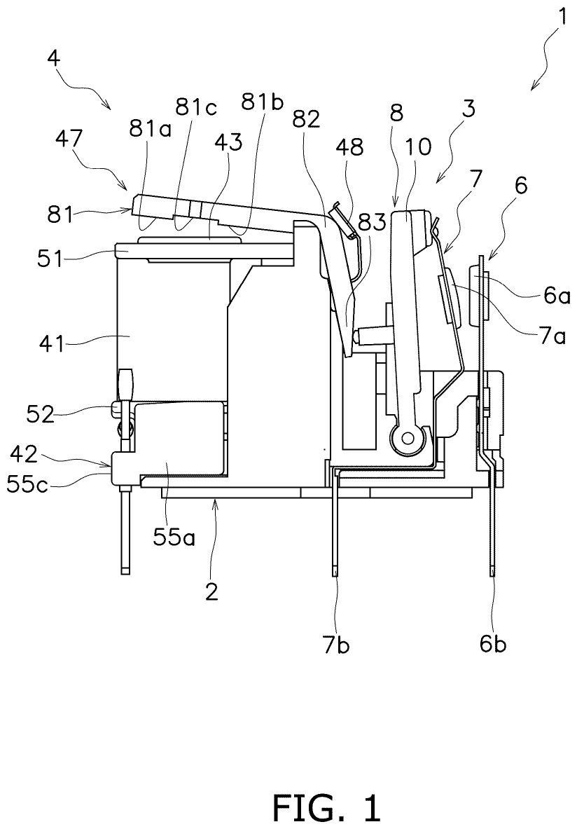

Hereinafter, an embodiment of an electromagnetic relay according to one aspect of the claimed invention will be described with reference to the drawings. For ease of description when referring to the drawings, the upper side in FIG. 1 will be referred to as “upper,” the lower side as “lower,” the left side as “left,” the right side as “right,” the near side of the sheet as “front,” and the far side as “rear.”

The electromagnetic relay 1 is a hinge-type electromagnetic relay. The electromagnetic relay 1 is a latching-type electromagnetic relay. As illustrated in FIG. 1, the electromagnetic relay 1 includes a base 2, a contact device 3, and an electromagnet device 4. The base 2 is comprised of insulating material such as resin. A box-shaped cover member (not shown) is disposed above the base 2. The contact device 3 and the electromagnet device 4 are disposed in an internal space formed by the base 2 and the cover member.

The contact device 3 includes a fixed terminal 6, a movable contact piece 7, and an actuating mechanism 8. The fixed terminal 6 and the movable contact piece 7 are plate terminals and are comprised of conductive material. The fixed terminal 6 and the movable contact piece 7 are supported by the base 2 and extend upward from the base 2.

The fixed terminal 6 includes a fixed contact 6a and an external connection portion 6b. The fixed contact 6a is disposed above the base 2 and is located on the right surface of the fixed terminal 6.

The external connection portion 6b protrudes downward from the base 2 and is exposed to the outside. The external connection portion 6b is to be electrically connected to an external device (not shown).

The movable contact piece 7 is formed of an elastically deformable leaf spring and is arranged opposite the fixed terminal 6 in the left-right direction. In the present embodiment, the movable contact piece 7 is disposed to the left of the fixed terminal 6.

The movable contact piece 7 includes a movable contact 7a and an external connection portion 7b. The movable contact 7a is arranged opposite the fixed contact 6a and is configured to come into contact with the fixed contact 6a. The external connection portion 7b is to be electrically connected to an external device (not shown).

The actuating mechanism 8 moves the movable contact piece 7 in a direction in which the movable contact 7a approaches the fixed contact 6a and in a direction in which the movable contact 7a separates from the fixed contact 6a. In the present embodiment, the movement directions of the movable contact piece 7 correspond to the left-right direction.

The actuating mechanism 8 includes a card 10. The card 10 is rotatably supported by the base 2. The card 10 is rotatable in the left-right direction with the lower end of the card 10 serving as a pivot. The card 10 is disposed between the movable contact piece 7 and the electromagnet device 4. The card 10 is connected to both the movable contact piece 7 and the electromagnet device 4.

The electromagnet device 4 uses electromagnetic force to move the movable contact piece 7 via the actuating mechanism 8. The electromagnet device 4 rotates the card 10 by electromagnetic force, thereby moving the movable contact piece 7 in the left-right direction.

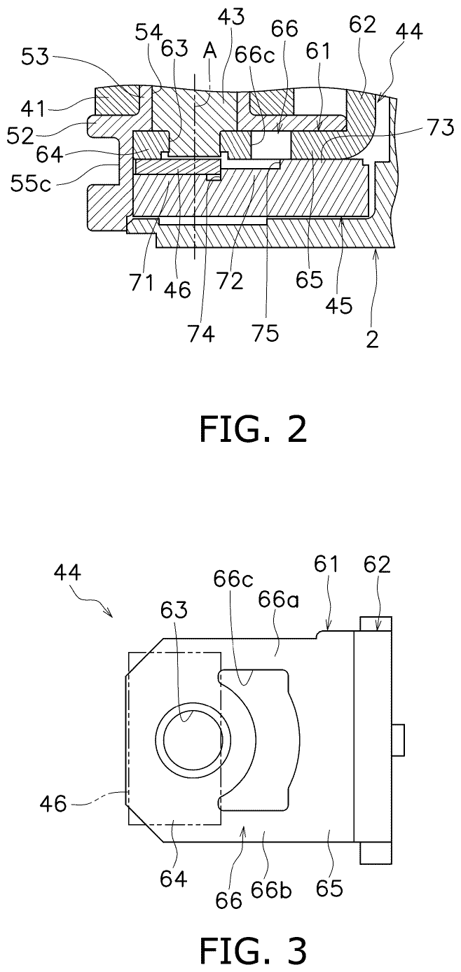

As illustrated in FIGS. 1 to 3, the electromagnet device 4 includes a coil 41, a spool 42, an iron core 43, a yoke 44, an auxiliary yoke 45, a permanent magnet 46, a movable iron piece 47, and a hinge spring 48.

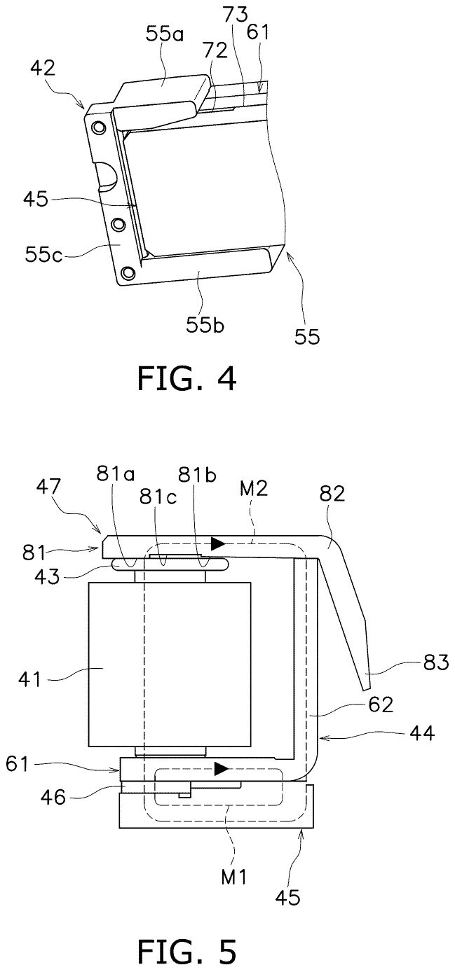

The coil 41 is wound around the outer periphery of the spool 42. The spool 42 extends in the up-down direction. The axial direction of the spool 42 corresponds to the up-down direction. The spool 42 includes a first flange 51, a second flange 52, a body portion 53, a housing portion 54, and a positioning portion 55 (see FIG. 4).

The first flange 51 is connected to the upper end of the body portion 53. The second flange 52 is connected to the lower end of the body portion 53. The first flange 51 and the second flange 52 extend in a direction intersecting the up-down direction. The first flange 51 and the second flange 52 each have an outer diameter larger than the outer diameter of the body portion 53.

The body portion 53 has a cylindrical shape, and the coil 41 is wound around its outer periphery. The body portion 53 extends in the up-down direction.

The housing portion 54 is located inside the body portion 53. The housing portion 54 is a circular hole when viewed from the up-down direction. The housing portion 54 is formed through the central portion of the body portion 53 in the up-down direction.

As illustrated in FIG. 4, the positioning portion 55 is configured to position the auxiliary yoke 45. The positioning portion 55 is arranged below the second flange 52. The positioning portion 55 extends downward from the outer edge of the second flange 52. The positioning portion 55 has a recessed shape extending from the left toward the right. The positioning portion 55 is open on the right and bottom sides.

Specifically, the positioning portion 55 includes a first side wall 55a, a second side wall 55b, and a connecting portion 55c. The first side wall 55a and the second side wall 55b extend in a direction intersecting the front-rear direction. The second side wall 55b is arranged opposite the first side wall 55a in the front-rear direction. The second side wall 55b is situated rearward of the first side wall 55a. The connecting portion 55c is connected to the left end of the first side wall 55a and the left end of the second side wall 55b. The connecting portion 55c extends in the front-rear direction.

The iron core 43 is disposed inside the spool 42. The iron core 43 is accommodated in the housing portion 54. The upper end of the iron core 43 is exposed from the housing portion 54. The lower end of the iron core 43 is fixed to the yoke 44 by caulking. The axis A of the iron core 43 extends in the up-down direction. In the present embodiment, the axial direction of the iron core 43 corresponds to the up-down direction.

The yoke 44 is connected to the iron core 43, the auxiliary yoke 45, and the permanent magnet 46. The yoke 44 has a bent L-shaped configuration. The yoke 44 rotatably supports the movable iron piece 47. The yoke 44 includes a base portion 61 and an extension portion 62.

The base portion 61 extends in a direction intersecting the up-down direction. The base portion 61 is disposed below the second flange 52. The base portion 61 is fixed to the lower end of the iron core 43. The base portion 61 is fixed to the lower end of the iron core 43 via a caulking hole 63, which will be described later. The base portion 61 is positioned by the positioning portion 55. The base portion 61 is disposed between the first side wall 55a and the second side wall 55b.

The base portion 61 includes the caulking hole 63, a first contact portion 64, a second contact portion 65, and a reduced cross-sectional area portion 66.

The caulking hole 63 penetrates the base portion 61 in the up-down direction. The caulking hole 63 also penetrates the first contact portion 64 in the up-down direction. The caulking hole 63 has a counterbored shape.

The first contact portion 64 is disposed above the permanent magnet 46 and contacts the permanent magnet 46. The lower surface of the first contact portion 64 contacts the upper surface of the permanent magnet 46. The first contact portion 64 is disposed near the caulking hole 63. A part of the first contact portion 64 is situated forward of the caulking hole 63.

The second contact portion 65 is disposed above the auxiliary yoke 45 and contacts the auxiliary yoke 45. The lower surface of the second contact portion 65 contacts the upper surface of the auxiliary yoke 45. The second contact portion 65 is spaced apart from the first contact portion 64 in the left-right direction. The second contact portion 65 is disposed to the right of the first contact portion 64 and the caulking hole 63. The second contact portion 65 is located closer to the extension portion 62 than to the first contact portion 64.

The reduced cross-sectional area portion 66 is disposed between the first contact portion 64 and the second contact portion 65. The cross-sectional area of the reduced cross-sectional area portion 66 is smaller than that of the second contact portion 65. Here, the cross-sectional area refers to the area of a cross-section taken along a plane orthogonal to the left-right direction. The reduced cross-sectional area portion 66 is spaced apart from the auxiliary yoke 45 in the up-down direction.

As illustrated in FIG. 3, the reduced cross-sectional area portion 66 includes a first connecting portion 66a, a second connecting portion 66b, and a through-hole 66c. The first connecting portion 66a and the second connecting portion 66b extend in the left-right direction. The first connecting portion 66a and the second connecting portion 66b are connected to the first contact portion 64 and the second contact portion 65. The first connecting portion 66a is situated forward of the caulking hole 63. The second connecting portion 66b is spaced apart from the first connecting portion 66a in the front-rear direction. The second connecting portion 66b is situated rearward of the caulking hole 63.

The through-hole 66c is located between the first connecting portion 66a and the second connecting portion 66b. The through-hole 66c penetrates the base portion 61 in the up-down direction. The through-hole 66c extends in the front-rear direction. The through-hole 66c has a width dimension greater than the inner diameter dimension of the caulking hole 63. The width dimension of the through-hole 66c refers to its dimension in the front-rear direction. The through-hole 66c is located to the right of the permanent magnet 46. It should be noted that in FIG. 3, the position of the permanent magnet 46 is illustrated schematically.

The extension portion 62 extends in a direction intersecting the left-right direction. The extension portion 62 is connected to the base portion 61. The extension portion 62 includes a portion extending upward from the right end of the base portion 61 in a bent manner. The extension portion 62 is disposed to the right side of the coil 41.

The auxiliary yoke 45 is connected to the base portion 61 of the yoke 44 on the exterior side of the base portion 61. The auxiliary yoke 45 is disposed below the base portion 61 of the yoke 44. In the up-down direction, the auxiliary yoke 45 is disposed between the base portion 61 of the yoke 44 and the base 2. The auxiliary yoke 45 contacts the second contact portion 65 of the base portion 61 of the yoke 44 and the permanent magnet 46. The auxiliary yoke 45 is held between the first side wall 55a and the second side wall 55b.

The auxiliary yoke 45 includes a magnet contact portion 71, an intermediate portion 72, and a yoke contact portion 73. The magnet contact portion 71 is configured to contact the permanent magnet 46. The magnet contact portion 71 is disposed below the first connecting portion 66a and the caulking hole 63. When viewed from the up-down direction, the magnet contact portion 71 overlaps the first connecting portion 66a and the caulking hole 63.

The intermediate portion 72 is disposed between the magnet contact portion 71 and the yoke contact portion 73. The intermediate portion 72 is spaced apart from the base portion 61 of the yoke 44 in the up-down direction, and a space is formed between the intermediate portion 72 and the base portion 61. The intermediate portion 72 is located below the reduced cross-sectional area portion 66 of the yoke 44. When viewed from the up-down direction, the intermediate portion 72 overlaps the reduced cross-sectional area portion 66. The intermediate portion 72 is spaced apart from the reduced cross-sectional area portion 66 in the up-down direction. The intermediate portion 72 protrudes upward beyond the magnet contact portion 71, and a step 74 (an example of the second step) is formed between the intermediate portion 72 and the magnet contact portion 71.

The yoke contact portion 73 is disposed to the right of the intermediate portion 72. The yoke contact portion 73 is configured to come into contact with the yoke 44. The yoke contact portion 73 contacts the second contact portion 65 of the yoke 44. The yoke contact portion 73 protrudes upward beyond the intermediate portion 72, and a step 75 (an example of the first step) is formed between the yoke contact portion 73 and the intermediate portion 72.

The permanent magnet 46 extends in a direction intersecting the up-down direction. The permanent magnet 46 has a width dimension greater than the inner diameter dimension of the caulking hole 63. The permanent magnet 46 is positioned on the extension line of the axis A of the iron core 43. The permanent magnet 46 is disposed between the base portion 61 of the yoke 44 and the auxiliary yoke 45. Specifically, the permanent magnet 46 is disposed between the first contact portion 64 of the yoke 44 and the magnet contact portion 71 of the auxiliary yoke 45. The upper surface of the permanent magnet 46 contacts the first contact portion 64, and the lower surface contacts the magnet contact portion 71. The permanent magnet 46 is disposed below the caulking hole 63. The permanent magnet 46 overlaps the caulking hole 63 when viewed from the up-down direction. The permanent magnet 46 is disposed to the left of the reduced cross-sectional area portion 66.

The permanent magnet 46 is spaced apart from the iron core 43 in the up-down direction. The permanent magnet 46 may be arranged such that the center of the cross-section of the permanent magnet 46 is aligned with the extension of the axis A of the iron core 43. The permanent magnet 46 is positioned by the step 74; the left side of the permanent magnet 46 is in contact with the step 74. The permanent magnet 46 also protrudes upward beyond the intermediate portion 72 of the auxiliary yoke 45.

The movable iron piece 47 is rotatably supported by the extension portion 62 of the yoke 44 via a hinge spring 48. The movable iron piece 47 is rotatable between a first position (illustrated in FIG. 1) and a second position (illustrated in FIG. 5). In the first position, the movable iron piece 47 is separated from the iron core 43. In the second position, the movable iron piece 47 is in contact with the iron core 43. The second position corresponds to the operating position of the movable iron piece 47.

The movable iron piece 47 includes an attracting portion 81, a bent portion 82, and a pressing portion 83. The attracting portion 81 is arranged opposite the upper end of the iron core 43 in the up-down direction. The attracting portion 81 is configured to contact the iron core 43 in the second position.

The attracting portion 81 includes a first protrusion 81a, a second protrusion 81b, and a recess 81c. The first protrusion 81a contacts the iron core 43 in the second position. The first protrusion 81a is located at the front end (left end) of the attracting portion 81. When viewed from the axial direction of the iron core (up-down direction), the first protrusion 81a overlaps the permanent magnet 46. The second protrusion 81b does not contact the iron core 43 in the second position. The second protrusion 81b does not overlap the permanent magnet 46 when viewed from the axial direction of the iron core (up-down direction). The first and second protrusions are spaced apart from each other in the left-right direction. The recess 81c has a shape recessed in a direction away from the iron core 43. The recess 81c is disposed between the first protrusion 81a and the second protrusion 81b. The recess 81c extends in the front-rear direction. When the movable iron piece 47 is at the second position, the recess 81c overlaps the upper end of the iron core 43 when viewed from the up-down direction. When the movable iron piece 47 is in the second position, the recess 81c is located on an extension line of the axis A of the iron core 43. When the movable iron piece 47 is in the second position, the recess 81c is positioned opposite the upper end of the iron core 43 and is spaced apart from the iron core 43. The recess 81c does not contact the iron core 43 when the movable iron piece 47 is in the second position.

The bent portion 82 is disposed at the upper end of the extension portion 62 of the yoke 44. The pressing portion 83 is connected to the card 10 and is configured to press the card 10 in accordance with the movement of the movable iron piece 47 from the first position to the second position.

The hinge spring 48 is fixed to the extension portion 62 of the yoke 44. The hinge spring 48 on the extension portion 62 of the yoke 44 serves to hold the movable iron piece 47.

Next, the operation of the electromagnetic relay 1 will be described. Since the operation of the electromagnetic relay 1 is similar to that of the conventional one, it will be described briefly. While no voltage is applied to the coil 41, the movable iron piece 47 is positioned in the first position by the elastic force of the movable contact piece 7, and the movable contact 7a is separated from the fixed contact 6a. In this state, the magnetic flux of the permanent magnet 46 generates a magnetic circuit MI passing through the auxiliary yoke 45 and the base portion 61 of the yoke 44, and a magnetic circuit M2 passing through the iron core 43, the movable iron piece 47, the yoke 44, and the auxiliary yoke 45.

When a voltage is applied to the coil 41 so as to generate a magnetic flux in the same direction as the magnetic flux flowing through the magnetic circuit M2, a magnetic circuit is formed through the iron core 43, the movable iron piece 47, and the yoke 44 by the magnetic flux generated by the voltage applied to the coil 41. As a result, the attractive force of the iron core 43 acting on the movable iron piece 47 increases, thereby causing the movable iron piece 47 to rotate and move from the first position to the second position. As the movable iron piece 47 moves from the first position to the second position, the card 10 is pressed by the movable iron piece 47, and the movable contact 7a comes into contact with the fixed contact 6a.

Even after the application of voltage to the coil 41 is stopped, the magnetic force of the magnetic circuit M2 is greater than the elastic force of the movable contact piece 7, and thereby the movable iron piece 47 is maintained at the second position.

When a return voltage in the direction opposite to the applied voltage is applied to the coil 41 so as to cancel out the magnetic force of the magnetic circuit M2, the movable iron piece 47 moves from the second position to the first position, thereby causing the movable contact 7a to separate from the fixed contact 6a.

In the electromagnet device 4 of the above-described electromagnetic relay 1, the auxiliary yoke 45 is connected to the base portion 61 of the yoke 44 on the exterior side of the base portion 61, and the permanent magnet 46 is disposed between the base portion 61 of the yoke 44 and the auxiliary yoke 45. That is, the auxiliary yoke 45 and the permanent magnet 46 are arranged on the exterior of the yoke 44. With this configuration, the permanent magnet 46 and the auxiliary yoke 45 can be assembled to the exterior of the yoke 44, thereby improving the assemblability of the electromagnet device 4. Moreover, the electromagnet device 4 according to the claimed invention can be assembled simply, for example, by attaching the permanent magnet 46 and the auxiliary yoke 45 to a conventional hinge-type single-stable electromagnet device 4 from the outside. Furthermore, the common components of the conventional hinge-type single-stable electromagnet device can be used, except for the permanent magnet 46 and the auxiliary yoke 45.

One embodiment of the electromagnetic relay according to one aspect of the claimed invention has been described above. However, the claimed invention is not limited to this embodiment, and various changes may be made without departing from the scope of the claimed invention.

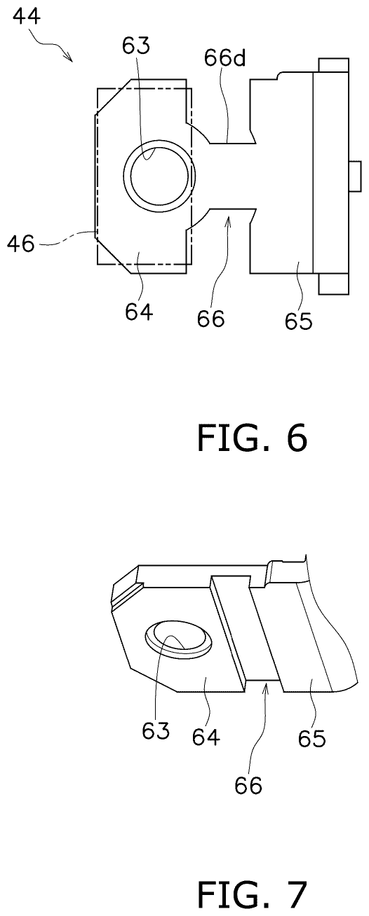

The shape of the yoke 44 may be changed. The reduced cross-sectional area portion 66 of the yoke 44 may include a constricted portion. Specifically, the reduced cross-sectional area portion 66 may include a constricted portion 66d, as illustrated in FIG. 6. The constricted portion 66d may have a width dimension smaller than that of the permanent magnet 46. The constricted portion 66d may have a width dimension similar to the inner diameter dimension of the caulking hole 63. The reduced cross-sectional area portion 66 may also have a smaller thickness than the second contact portion 65. As illustrated in FIG. 7, the constricted portion 66d may have a recessed shape on the lower surface of the base portion 61.

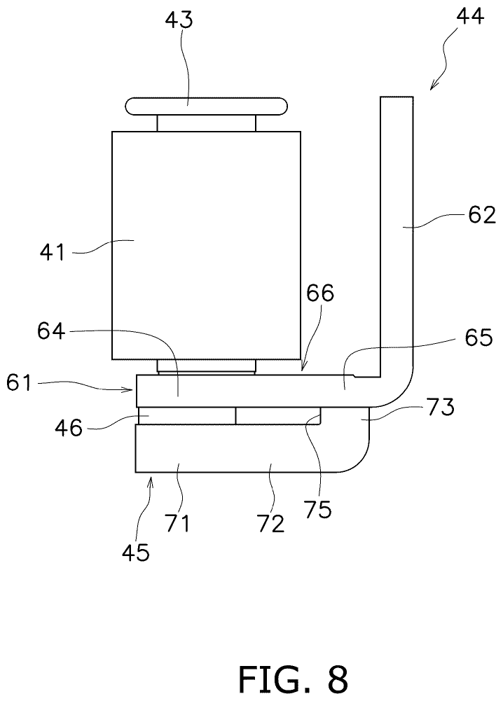

The shape of the auxiliary yoke 45 may also be changed. The step 74 may be omitted, and the intermediate portion 72 may be connected directly to the magnet contact portion 71 without steps, The yoke contact portion 73 may have a bent L-shaped configuration. As illustrated in FIG. 8, the yoke contact portion 73 may include a part extending from the right end of the intermediate portion 72 in a bent manner to contact the second contact portion 65.

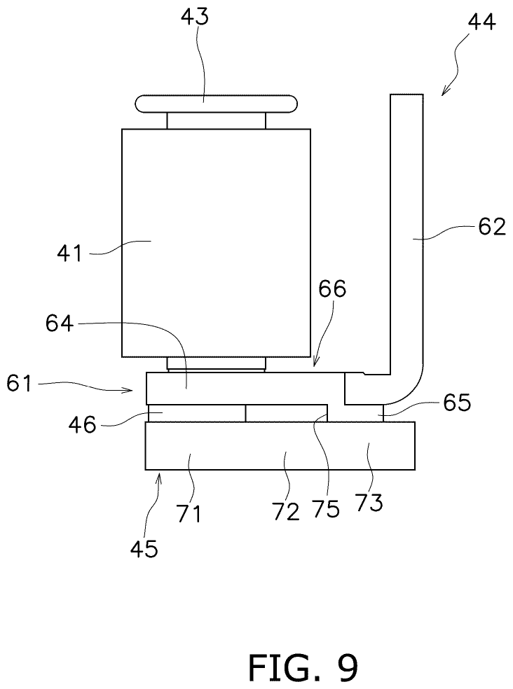

The auxiliary yoke 45 may have a flat upper surface, and the intermediate portion 72 is connected directly to the magnet contact portion 71 and the yoke contact portion 73 without steps. In this case, as illustrated in FIG. 9, the second contact portion 65 of the yoke 44 may have a shape protruding toward the yoke contact portion 73.

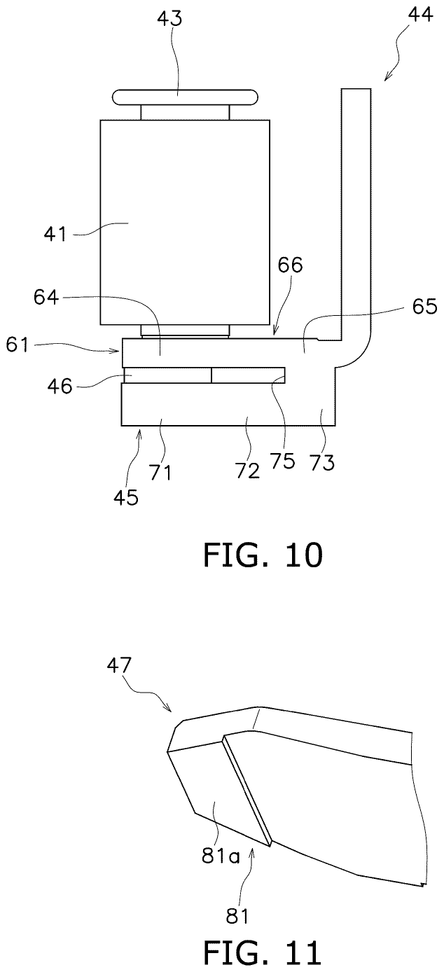

As illustrated in FIG. 10, the auxiliary yoke 45 may be integral with the yoke 44. For example, the auxiliary yoke 45 may be formed integrally with the yoke 44 by hemming a part of the yoke 44.

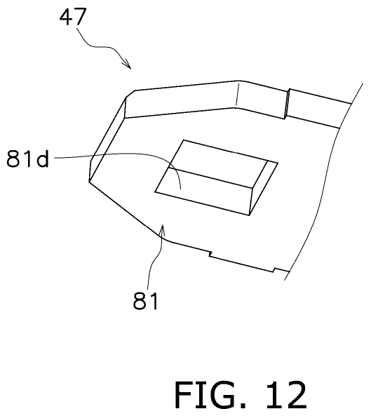

The configuration of the movable iron piece 47 may also be changed. As illustrated in FIG. 11, the second protrusion 81b and the recess 81c of the attracting portion 81 in the movable iron piece 47 may be omitted. That is, the tip of the attracting portion 81 may protrude toward the yoke contact portion 73. As illustrated in FIG. 12, the attracting portion 81 may also include a through-hole 81d extending in the axial direction.

The configuration of the contact device 3 may be changed. The claimed invention may be applied to a contact device in which the movable contact 7a rotates integrally with the movable iron piece 47. The orientation of the electromagnet device 4 may also be changed. The electromagnet device 4 may be arranged such that the axial direction of the iron core 43 corresponds to the left-right direction.

In the embodiment described above, the auxiliary yoke 45 is positioned by the spool 42. However, the auxiliary yoke 45 may instead be positioned by the yoke 44. For example, the auxiliary yoke 45 may be fixed to the yoke 44 by engaging in a concavo-convex fitting arrangement with the base portion 61 of the yoke 44.

### REFERENCE NUMERALS

1: Electromagnetic relay, 41: Coil, 42: Spool, 43; Iron core, 44: Yoke, 45: Auxiliary yoke, 46: Permanent magnet, 47: Movable iron piece, 61: Base portion, 62: Extension portion, 63: Caulking hole, 64: First contact portion, 65: Second contact portion, 66: Reduced cross-sectional area portion, 66c: Through-hole, 66d: Constricted portion, 71: Magnet contact portion, 72: Intermediate portion, 73: Yoke contact portion, 81: Attracting portion

What is claimed is

1. An electromagnet device, comprising:
a coil;
a spool around which the coil is wound;
an iron core disposed inside the spool;
a yoke including a base portion and an extension portion, the base portion extending in a direction intersecting an axial direction of the iron core, the base portion being fixed to one end of the iron core, the extension portion being connected to the base portion, the extension portion being arranged laterally relative to the coil;
a movable iron piece rotatably supported by the extension portion of the yoke;
an auxiliary yoke connected to the base portion of the yoke on an exterior side of the base portion; and
a permanent magnet positioned on an extension line of an axis of the iron core, the permanent magnet being disposed between the base portion of the yoke and the auxiliary yoke.

2. The electromagnet device according to claim 1, wherein
the base portion of the yoke includes a first contact portion configured to contact the permanent magnet, a second contact portion configured to contact the auxiliary yoke, and a reduced cross-sectional area portion disposed between the first contact portion and the second contact portion, and
the reduced cross-sectional area portion is spaced apart from the auxiliary yoke in the axial direction, the reduced cross-sectional area portion having a smaller cross-sectional area than a cross-sectional area of the second contact portion.

3. The electromagnet device according to claim 2, wherein
the reduced cross-sectional area portion includes a through-hole that penetrates the base portion in the axial direction.

4. The electromagnet device according to claim 3, wherein
the base portion further includes a caulking hole, and
the through-hole of the reduced cross-sectional area portion has a width dimension greater than an inner diameter dimension of the caulking hole.

5. The electromagnet device according to claim 2, wherein
the reduced cross-sectional area portion includes a constricted portion, and
the constricted portion has a width dimension smaller than a width dimension of the permanent magnet.

6. The electromagnet device according to claim 2, wherein
the reduced cross-sectional area portion has a thickness smaller than a thickness of the second contact portion.

7. The electromagnet device according to claim 2, wherein
the auxiliary yoke includes a magnet contact portion configured to contact the permanent magnet, a yoke contact portion configured to contact the yoke, an intermediate portion disposed between the magnet contact portion and the yoke contact portion, and a first step formed between the intermediate portion and the yoke contact portion, the intermediate portion being spaced apart from the yoke in the axial direction.

8. The electromagnet device according to claim 7, wherein
the auxiliary yoke further includes a second step formed between the magnet contact portion and the intermediate portion, and
the permanent magnet contacts the second step.

9. The electromagnet device according to claim 7, wherein
the yoke contact portion of the auxiliary yoke has a bent shape.

10. The electromagnet device according to claim 7, wherein
the second contact portion of the base portion of the yoke has a shape protruding toward the yoke contact portion, the second contact portion of the base portion of the yoke being configured to contact the yoke contact portion.

11. The electromagnet device according to claim 1, wherein
the auxiliary yoke is integral with the yoke.

12. The electromagnet device according to claim 1, wherein
the movable iron piece includes an attracting portion configured to be attracted to the iron core, and
the attracting portion includes a recess recessed in a direction away from the iron core.

13. The electromagnet device according to claim 1, wherein
the movable iron piece includes an attracting portion configured to be attracted to the iron core, and
the attracting portion further includes a first protrusion contactable with the iron core.

14. The electromagnet device according to claim 1, wherein
the movable iron piece includes an attracting portion configured to be attracted to the iron core, and
the attracting portion includes a through-hole that penetrates in the axial direction.

15. The electromagnet device according to claim 1, wherein
the spool includes a positioning portion configured to position the auxiliary yoke,
the positioning portion includes a first side wall and a second side wall facing the first side wall, and
the auxiliary yoke is held between the first side wall and the second side wall.
